(19) United States
(12) Patent Application Publication
(10) Pub. No.: US 2010/0082639 A1
(43) Pub. Date: Apr. 1, 2010

(54) PROCESSING MAXIMUM LIKELIHOOD FOR LISTWISE RANKINGS

(75) Inventors: Hang Li, Beijing (CN); Tie-Yan Liu, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/242,657

(22) Filed: Sep. 30, 2008

(51) Int. Cl. G06F 17/30

(52) U.S. Cl. 707/748; 707/E17.017; 707/E17.044

(57) ABSTRACT

The present invention introduces a new approach to learning systems. More specifically, the present invention provides learned methods for optimize ranking models. In one aspect of the present invention, an objective function is defined as the likelihood of ground truth based on a Luce model. In another aspect, techniques of the present invention provide a way of representing different kinds of ground truths as a constraint set of permutations. In yet another aspect of the present invention, techniques of the present invention provide a way of learning the model parameter by maximizing the likelihood of the ground truth.

### BACKGROUND

Ranking, which is a process to sort objects based on certain factors, is the central problem of applications such as information retrieval (IR) and information filtering. Recently machine learning technologies called ‘learning to rank’ have been successfully applied to ranking, and several approaches have been proposed, including the pointwise, pairwise, and listwise approaches. The subject of ranking presents many challenges in area of Web Search. In recent years machine learning technologies have been widely used to learn the ranking model from training data.

ListNet is an existing ranking technology. In ListNet, techniques calculate a permutation probability distribution from the scores outputted by the ranking model according to the Luce Model, and further assume the ground truth to be scores assigned to documents as well, so as to calculate the probability distribution of the ground truth. After that, a loss function is defined as the cross entropy between these two probability distributions.

While ListNet has demonstrated significant improvement over other technologies, some improvements could be made. Specifically, while it is reasonable to treat the output of the ranking model as real-valued scores, it is not the case for the ground truth. Two widely-used labeling data methods include: ordered categories and pairwise preferences. For either of them, there is only the ordering information, but no real-valued information in the labels. In this case, if one is required to map this ordered information to real-valued scores, different mapping schemes may result in quite different probability distributions. Thus, the performance of ListNet is sensitive to the mapping function, and one can hardly explain which mapping is the best theoretically.

### SUMMARY

The present invention introduces a new approach to learning systems. More specifically, the present invention provides ways to optimize ranking models. In one aspect of the present invention, an objective function is defined as the likelihood of ground truth based on a Luce model. The process involves the analysis of gathered data to ultimately determine if the ranking results on a given ranking model are accurate or not. In one embodiment, the process involves the receipt of a data set to be analyzed. The data set can include a list of search queries, documents to be searched and related metadata. The data set may be gathered from a number of sources, such as the query log of a search system. The metadata, also referred to herein as labeling data, can be human added information, or tag information that may have been automatically associated with the documents. The metadata can describe a number of things about the documents, for example, it may say that the document is “bad” or “good,” or it may state that it is “perfect” or “excellent,” etc. The metadata may also include pairwise indicators.

As described in more detail below, the process involves defining an objective function. Next, a value of the objective function is calculated. The value is used to measure whether the ranking results on a given ranking model is accurate or not. The process also includes a tuning technique, where the process modifies the parameters of a ranking model depending on the value of the objective function. The process can then run several iterations to more accurately tune the model parameters. As parameters of the ranking model are changed by this process, the ranking model becomes more accurate, which in turn, may be used to better assist a search system such as a page ranking system.

In another aspect, techniques of the present invention provide a way of representing different kinds of ground truths as a constraint set of permutations. This is one way to define the objective function in situations where the ranking data is incomplete, e.g., all of the documents do not have ranking data.

In order to define and fully utilize the Luce model, it is necessary to have a complete set of labeling data as permutations. Human added labels or metadata may not give enough data to rank all of the documents. In some cases, human added metadata can only give an independent reading on ranked documents. For example, human added labels can give a pairwise ranking, which gives a relative ranking for two documents. To accommodate incomplete data sets, the invention represents the training data in a way that can fit into the Luce model. In one embodiment, the invention includes the use of categories. When the labels involved categories, e.g., “perfect” or “excellent,” the invention represents these labels in a set of permutations. In another embodiment, the human added labels are given as a pairwise ranking. In this situation, the solution represents the set as a constrained set of the permutation.

In yet another aspect of the present invention, techniques of the present invention provide a way learning the model parameter by maximizing the likelihood of the ground truth. In brief, this process involves optimizing the objective function. In one embodiment, the process computes the likelihood by the Luce Model. Having the likelihood, it then computes the gradient with respect to each feature dimension of a given data set, e.g., metadata. The process then computes the gradient of the likelihood with respect to the components of the model parameter. Next, the process adjusts the model parameter, wherein the direction of the change is dictated by the gradient. By changing the model parameter, the original likelihood will be maximized and the ranking model will be optimized.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Below, the application first introduces the theory of the invention followed by a more detailed description of the various embodiments.

### BRIEF DESCRIPTION OF THE DRAWINGS

FIG. 1A illustrates a chart of the ranking scores of a predicted result.

FIG. 1 B illustrates a chart of the loss φ v.s. d for the likelihood loss.

FIG. 2A illustrates a chart of the ranking scores of predicted result and ground truth.

FIG. 2B illustrates a chart of the Loss φ v.s. angle α for the cosine loss.

FIG. 3A illustrates a chart of the ranking scores of predicted result and ground truth

FIG. 3B illustrates a chart of the Loss φ v.s. d for the cross entropy loss.

FIG. 4 provides a summary of the properties of the loss functions.

FIG. 5 illustrates a chart of the ranking performance on OHSUMED data.

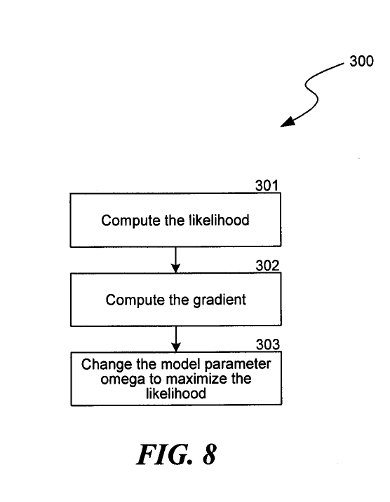

FIG. 6 is a block flow diagram covering the process involved with defining an objective function as the likelihood of ground truth based on a Luce model.

FIG. 7 is a block flow diagram covering techniques for representing different kinds of ground truths as a constraint set of permutations.

FIG. 8 is a block flow diagram covering techniques for learning the model parameter by maximizing the likelihood of the ground truth.

### DETAILED DESCRIPTION

Ranking, which is a way to sort objects based on certain factors, is the central problem of applications such as information retrieval (IR) and information filtering. Recently machine learning technologies called ‘learning to rank’ have been successfully applied to ranking, and several approaches have been proposed, including the pointwise, pairwise, and listwise approaches.

The listwise approach addresses the ranking problem in the following way. In learning, it takes ranked lists of objects (e.g., ranked lists of documents in IR) as instances and trains a ranking function through the minimization of a listwise loss function defined on the predicted list and the ground truth list. The listwise approach captures the ranking problems, particularly those in IR in a conceptually more natural way than previous work.

In accordance with the present invention, the listwise approach focuses on the development of new algorithms, such as RankCosine and ListNet. However, there was little sufficient theoretical foundation established. Furthermore, the strength and limitation of the algorithms, and the relations between the proposed algorithms were still not clear. This largely prevented us from deeply understanding the approach, more critically, from devising more advanced algorithms.

The following summary provides a formal definition of the listwise approach. In ranking, the input is a set of objects, the output is a permutation of the objects, and the model is a ranking function which maps a given input to an output. In learning, the training data is drawn independently and identically distributed according to an unknown but fixed joint probability distribution between input and output. Ideally we would minimize the expected 0-1 loss defined on the predicted list and the ground truth list. Practically we instead manage to minimize an empirical surrogate loss with respect to the training data.

Second, the summary covers an evaluation of a surrogate loss function from four aspects: (a) consistency, (b) soundness, (c) mathematical properties of continuity, differentiability, and convexity, and (d) computational efficiency in learning. We give analysis on three loss functions: likelihood loss, cosine loss, and cross entropy loss.

Third, the summary provides a novel method for the listwise approach, which is called ListMLE. ListMLE formalizes learning to rank as a problem of minimizing the likelihood loss function, equivalently maximizing the likelihood function of a probability model. Due to the properties of the loss function, ListMLE stands to be more effective than RankCosine and ListNet. In addition, the following explains the verification of the correctness of the theoretical findings.

As described below, this summary of the present invention first introduces related work, then covers a formal definition to the listwise approach. Following sections covers a theoretical analysis of listwise loss functions, and introduces the ListMLE method.

Existing methods for learning to rank fall into three categories. The approach known as pointwise transforms ranking into regression or classification on single objects. The approach known as pairwise transforms ranking into classification on object pairs. The advantage for these two approaches is that existing theories and algorithms on regression or classification can be directly applied, but the problem is that they do not model the ranking problem in a straightforward fashion. The listwise approach can overcome the drawback of the aforementioned two approaches by tackling the ranking problem directly, as explained below.

For instance, it was proposed that one of the first listwise methods, called ListNet, in which the listwise loss function is defined as cross entropy between two parameterized probability distributions of permutations; one is obtained from the predicted result and the other is from the ground truth. Other work proposed another method called RankCosine. In this method, the listwise loss function is defined on the basis of cosine similarity between two score vectors from the predicted result and the ground truth. Experimental results show that the listwise approach usually outperforms the pointwise and pariwise approaches.

This disclosure of the present invention aims to investigate the listwise approach to learning to rank, particularly from the viewpoint of loss functions. Actually similar investigations have also been conducted for classification. For instance, in classification, consistency and soundness of loss functions were studied. Consistency forms the basis for the success of a loss function. It is known that if a loss function is consistent, then the learned classifier can achieve the optimal Bayes error rate in the large sample limit. Many well-known loss functions such as hinge loss, exponential loss, and logistic loss are all consistent. Soundness of a loss function guarantees that the loss can represent well the targeted learning problem. That is, an incorrect prediction should receive a larger penalty than a correct prediction, and the penalty should reflect the confidence of prediction. For example, hinge loss, exponential loss, and logistic loss are sound for classification. In contrast, square loss is sound for regression but not for classification.

The following section provides a formal definition of the listwise approach to learning to rank. Let X be the input space whose elements are sets of objects to be ranked, Y be the output space whose elements are permutations of objects, and P_{XY} be an unknown butxed joint probability distribution of X and Y. Let h: X→Y be a ranking function, and H be the corresponding function space (i.e., h ε H). Let x ε Y and y ε Y, and let y(i) be the index of object which is ranked at position i. The task is to learn a ranking function that can minimize the expected loss R(h), defined as:

R(h)=∫_{X×Y}l(h(x),y)dP(x,y) (1)

where l(h(x),y) is the 0-1 loss function such that

$$l ( h ( x ) , y ) = \{ \begin{matrix}1 , & if h ( x ) \neq y \\ 0 , & if h ( x ) = y\end{matrix} \qquad ( 2 )$$

The idea is to formalize the ranking problem as a new classification problem on permutations. If the permutation of the predicted result is the same as the ground truth, then we have zero loss; otherwise it will have one loss. In real ranking applications, the loss can be cost-sensitive, i.e., depending on the positions of the incorrectly ranked objects. We will leave this as our future work and focus on the 0-1 loss in this paper first. Actually, in the literature of classification, people also studied the 0-1 loss first, before they eventually moved onto the cost-sensitive case.

It is easy to see that the optimal ranking function which can minimize the expected loss R (h_{B})=inf R(h) is given by the Bayes rule,

$${h}_{B} ( x ) = arg {max}_{y ∈ Y} P ( y \vert x ) , \qquad ( 3 )$$

Since P_{XY} is unknown, formula (1) cannot be directly solved and thus h_{B}(x) cannot be easily obtained. In practice, we are given independently and identically distributed (i.i.d.) samples

$$S = \{ ( {x}^{( i )} , {y}^{( i )} ) \} {m}_{i = 1} ∼ {P}_{XY}$$

we instead try to obtain a ranking function h ε H that minimizes the empirical loss.

$${R}_{S} ( h ) = \frac{1}{m} {\sum }_{i = 1}^{m} l ( h ( {x}^{( i )} ) , {y}^{( i )} ) \qquad ( 4 )$$

Note that for efficiency consideration, in practice the ranking function usually works on individual objects. It assigns a score to each object (by employing a scoring function g), sorts the objects in descending order of the scores, and finally creates the ranked list. That is to say, h(x⁽ⁱ⁾) is decomposable with respect to objects. It is defined as

$$h ( {x}^{( i )} ) = sort ( g ( {x}_{1}^{( i )} ) , … , g ( {x}_{{n}_{i}}^{( i )} ) ) \qquad ( 5 )$$

where xⱼ⁽ⁱ⁾ ε x⁽ⁱ⁾, nᵢ denotes the number of objects in x⁽ⁱ⁾, g(·) denotes the scoring function, and sort(·) denotes the sorting function. As a result, (4) becomes:

$${R}_{S} ( g ) = \frac{1}{m} {\sum }_{i = 1}^{m} l ( sort ( g ( {x}_{1}^{( i )} ) , … , g ( {x}_{{n}_{i}}^{( i )} ) ) , {y}^{( i )} ) \qquad ( 6 )$$

Due to the nature of the sorting function and the 0-1 loss function, the empirical loss in Equation (6) is inherently non-differentiable with respect to g, which poses a challenge to the optimization of it. To tackle this problem, we can introduce a surrogate loss as an approximation of (Equation 6), following a common practice in machine learning.

$${R}_{S}^{φ} ( g ) = \frac{1}{m} {\sum }_{i = 1}^{m} φ ( g ( {x}^{( i )} ) , {y}^{( i )} ) , \qquad ( 7 )$$

where φ is a surrogate loss function and g(x⁽ⁱ⁾)=(g(x₁⁽ⁱ⁾), . . . ,g(xₙ_{ᵢ}⁽ⁱ⁾). For convenience in notation, in the following sections, we sometimes write φ_{y}(g) for φ(g(x),y) and use bold symbols such as g to denote vectors since for a given x,g(y) becomes a vector.

For illustrative purposes, properties of the Loss Function are discussed. We analyze the listwise approach from the viewpoint of surrogate loss function. Specifically, the following properties of it are covered: (a) consistency, (b) soundness, (c) continuity, differentiability, and convexity, and (d) computational efficiency in learning.

Consistency is about whether the obtained ranking function can converge to the optimal one through the minimization of the empirical surrogate loss (Equation 7), when the training sample size goes to infinity. It is a necessary condition for a surrogate loss function to be a good one for a learning algorithm.

Soundness is about whether the loss function can indeed represent loss in ranking. For example, an incorrect ranking should receive a larger penalty than a correct ranking, and the penalty should reflect the confidence of the ranking. This property is particularly important when the size of training data is small, because it can directly affect the training results.

The following conducts analysis on learning to rank algorithms from the viewpoint of consistency. In the large sample limit, minimizing the empirical surrogate loss (Equation 7) amounts to minimizing the following expected surrogate loss

$${R}^{φ} ( g ) = {E}_{X , Y} \{ {φ}_{y} ( g ( x ) ) \} = {E}_{X} \{ Q ( g ( x ) ) \} \\ where \\ Q ( g ( x ) ) = {\sum }_{y ∈ Y} P ( y \vert x ) {φ}_{y} ( g ( x ) ) \qquad ( 8 )$$

Here we assume g(x) is chosen from a vector Borel measurable function set, whose elements can take any value from Ω⊂Rⁿ.

When the minimization of (Equation 8) can lead to the minimization of the expected 0-1 loss (1), we say the surrogate loss function is consistent. An equivalent definition can be found in Definition 2. Actually this equivalence relationship has been discussed in related work on the consistency of classification.

Definition 1. We define Λ_{y} as the space of all possible probabilities on the permutation space Y, i.e., Λ_{y} [symbol] {p ε R^{|Y|}:Σ_{yεY}p_{y}=1,p_{y}≧0}.

Definition 2. The loss φ_{y}(g) is consistent on a set Ω⊂Rⁿ with respect to the ranking loss (1), if the following conditions hold: ∀pεΛ_{Y}, assume y*=arg max_{yεY}p_{y} and Y_{y*}^{c} denotes the space of permutations after removing y*, we have

$${inf}_{g ∈ Ω} Q ( g ) < {inf}_{g ∈ Ω , sort ( g ) ∈ {Y}_{{y}^{*}}^{c}} Q ( g )$$

We next give sufficient conditions of consistency in ranking.

Definition 3. A permutation probability space Λ_{Y} is order preserving with respect to object i and i, if the following conditions hold: ∀y ε Y_{i,j} [symbol] {Y ε Y:y⁻¹(i)<y⁻¹(j)} where y⁻¹(i) denotes the position for object i in y, denote σ⁻¹y as the permutation which exchanges the positions of object i and j while hold others unchanged for y, we have P_{y}>P_{σ}_{^{−1}}_{y}.

Definition 4. The loss φ_{y}(g) is order sensitive on a set Ω⊂Rⁿ, if φ_{y}(g) is a non-negative differentiable function and the following two conditions hold:
1. ∀y ε Y, ∀i<j, denote σy as the permutation which exchanges the object on position i and that on position j while holds others unchanged for y, if g_{y(i)}<g_{y(j)}, then φ_{y}(g)≧φ_{σy}(g) and with at least one y, the strict inequality holds.
2. If gᵢ=gⱼ, then either

$$∀ y ∈ {Y}_{i , j} , \frac{\partial {φ}_{y} ( g )}{\partial {g}_{i}} \leq \frac{\partial {φ}_{y} ( g )}{\partial {g}_{j}} , ∀ y ∈ {Y}_{i , j} , \frac{\partial {φ}_{y} ( g )}{\partial {g}_{i}} \geq \frac{\partial {φ}_{y} ( g )}{\partial {g}_{j}} ,$$

and with at least one y, the strict inequality holds.

Theorem 5. Let φ_{y}(g) be an order sensitive loss function on Ω⊂Rⁿ. ∀n objects, if its permutation probability space is order preserving with respect to n−1 objective pairs (j₁,j₂), (j₂,j₃), . . . , (jₙ−1,jₙ). Then the loss φ_{y}(g) is consistent with respect to (Equation 1).

A sketch proof is now given for illustrative purposes. First, we can show if the permutation probability space is order preserving with respect to n−1 objective pairs (j₁,j₂), (j₂,j₃), . . . , (jₙ−1,jₙ), then the permutation with the maximum probability is y*=(j₁,j₂, . . . , jₙ). Second, for an order sensitive loss function, for any order preserving object pairs (j₁,j₂), the vector g which minimizes Q(g) in (Equation 8) should assign a larger score to j₁ than to j₂. This can be proven by the change of loss due to exchanging the scores of j₁ and j₂. Given all these results and Definition 2, we can prove Theorem 5 by means of contradiction.

Theorem 5 gives sufficient conditions for a surrogate loss function to be consistent: the permutation probability space should be order preserving and the function should be order sensitive. Actually, the assumption of order preserving has already been made when we use the scoring function and sorting function for ranking. The property of order sensitive shows that starting with a ground truth permutation, the loss will increase if we exchange the positions of two objects in it, and the speed of increase in loss is sensitive to the positions of objects.

The following section covers Likelihood Loss. A new loss function is introduced in the listwise approach, which we call likelihood loss. The likelihood loss function is defined as:

$$φ ( g ( x ) , y ) = - log P ( y \vert x ; g ) \\ where \\ P ( y \vert x ; g ) = {\prod }_{i = 1}^{n} \frac{exp ( g ( {x}_{y ( i )} ) )}{{\sum }_{k = i}^{n} exp ( g ( {x}_{y ( k )} ) )} . \qquad ( 9 )$$

Note that we actually define a parameterized exponential probability distribution over all the permutations given the predicted result (by the ranking function), and define the loss function as the negative log likelihood of the ground truth list. The probability distribution turns out to be a Plackett-Luce model. The likelihood loss function has the nice properties as discussed below.

First, the likelihood loss is consistent. The following proposition shows that the likelihood loss is order sensitive. Therefore, according to Theorem 5, it is consistent.

Proposition 6. The likelihood loss (9) is order sensitive on Ω⊂Rⁿ.

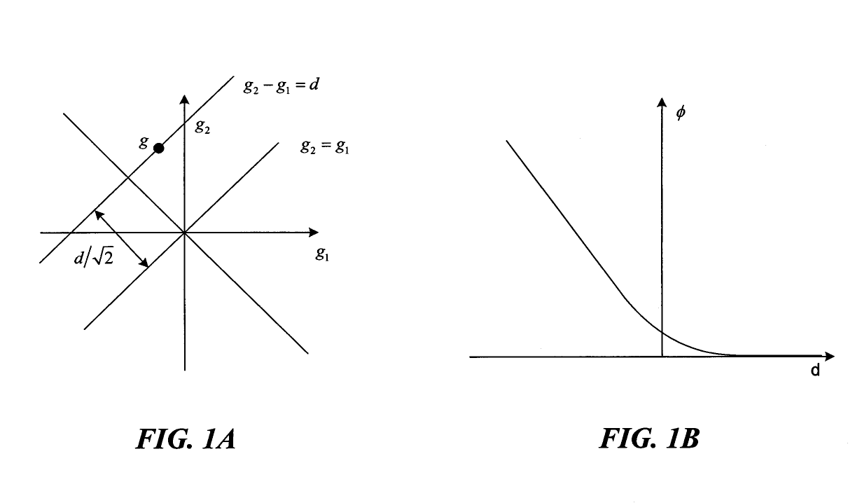

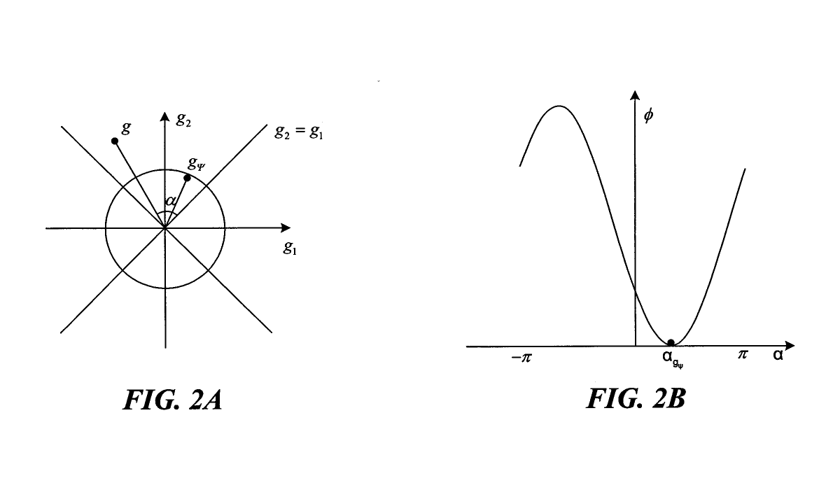

Second, the likelihood loss function is sound. For simplicity, suppose that there are two objects to be ranked (similar argument can be made when there are more objects). The two objects receive scores of g₁ and g₂ from a ranking function. FIG. 1A shows the scores, and the point g=(g₁,g₂). Suppose that first object is ranked below the second object in the ground truth. Then the upper left area above line g₂=g₁ corresponds to correct ranking; and the lower right area incorrect ranking. According to the definition of likelihood loss, all the points on the line g₂=g₁+d has the same loss. Therefore, we say the likelihood loss only depends on d. FIG. 1B shows the relation between the loss function and d. We can see the loss function decreases monotonously as d increases. It penalizes negative values of d more heavily than positive ones. This will make the learning algorithm focus more on avoiding incorrect rankings. In this regard, the loss function is a good approximation of the 0-1 loss.

Third, it is easy to verify that the likelihood loss is continuous, differentiable, and convex. Furthermore, the loss can be computed efficiently, with time complexity of linear order to the number of objects. With the above good properties, a learning algorithm which optimizes the likelihood loss will become powerful for creating a ranking function.

The cosine loss is the loss function used in RankCosine, a listwise method. It is defined on the basis of the cosine similarity between the score vector of the ground truth and that of the predicted result.

$$φ ( g ( x ) , y ) = \frac{1}{2} ( 1 - \frac{{{ψ}_{y} ( x )}^{T} g ( x )}{‖ {ψ}_{y} ( x ) ‖ ‖ g ( x ) ‖} ) \qquad ( 10 )$$

The score vector of the ground truth is produced by a mapping ψ_{y}(·):R^{d}→R, which retains the order in a permutation, i.e., ψ_{y}(x_{y(1)})> . . . >ψ_{y}(x_{y(n)}).

Proposition 7. The cosine loss (Equation 10) is order sensitive on Ω⊂Rⁿ.

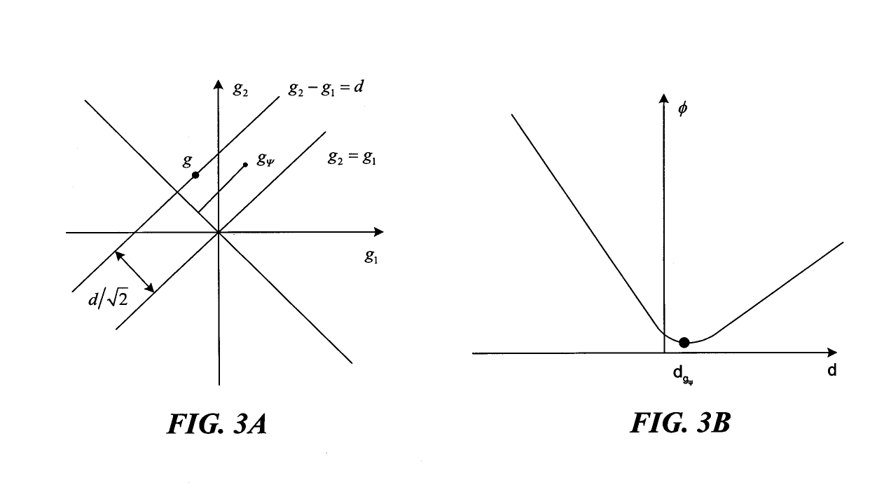

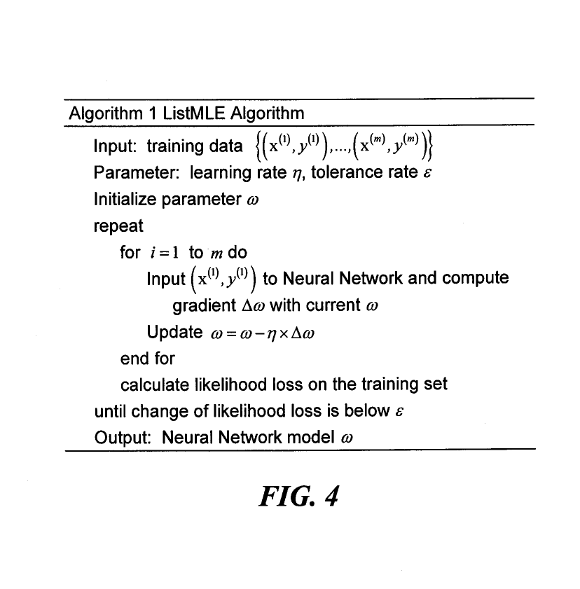

Second, the cosine loss is not very sound. Let us again consider the case of ranking two objects. FIG. 2(a) shows point g=(g₁,g₂) representing the scores of the predicted result and point g_{ψ} representing the ground truth (which depends on the mapping function ψ). We denote the angle from point g to line g₂=g₁ as α, and the angle from g_{ψ} to line g₂=g₁ as α_{g}_{_{ψ}}. We investigate the relation between the loss and the angle α. FIG. 2(b) shows the cosine loss as a function of α. From this figure, we can see that the cosine loss is not a monotonously decreasing function of α. When α>α_{g}_{_{ψ}}, it increases quickly, which means that it can heavily penalize correct rankings. Furthermore, the mapping function and thus α_{g}_{_{ψ}} can also affect the loss function. Specifically, the curve of the loss function can shift from left to right with different values of α>α_{g}_{_{ψ}}. Only when αg_{_{ψ}}=π/2, it becomes a relatively satisfactory representation of loss for the learning problem.

Third, it is easy to see that the cosine loss is continuous, differentiable, but not convex. It can also be computed in an efficient manner with a time complexity linear to the number of objects.

The cross entropy loss is the loss function used in List Net, another listwise method. The cross entropy loss function is defined as:

$$φ ( g ( x ) , y ) = D ( P ( π \vert x ; {ψ}_{y} ) ) ‖ P ( π \vert x ; g ) \\ where \\ P ( π \vert x ; {ψ}_{y} ) = {\prod }_{i = 1}^{n} \frac{exp ( {ψ}_{y} ( {x}_{π ( i )} ) )}{{\sum }_{k = i}^{n} exp ( {ψ}_{y} ( {x}_{π ( k )} ) )} \\ P ( π \vert x ; g ) = {\prod }_{i = 1}^{n} \frac{exp ( g ( {x}_{π ( i )} ) )}{{\sum }_{k = i}^{n} exp ( g ( {x}_{π ( k )} ) )} \qquad ( 11 )$$

where ψ is a mapping function whose definition is similar to that in RankCosine.

First, we can prove that the cross entropy loss is consistent, given the following proposition. Due to space limitations, we omit the proof.

Proposition 8. The cross entropy loss (Equation 11) is order sensitive on Ω⊂Rⁿ.

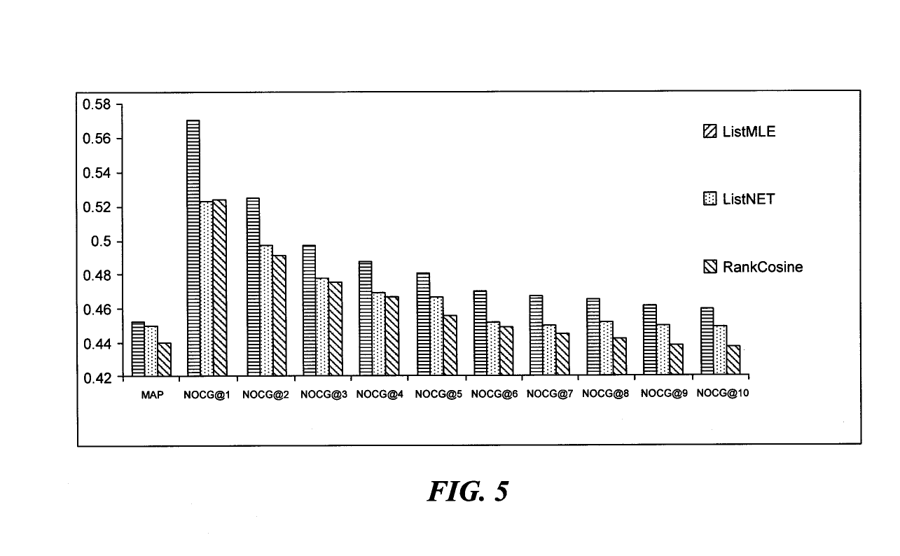

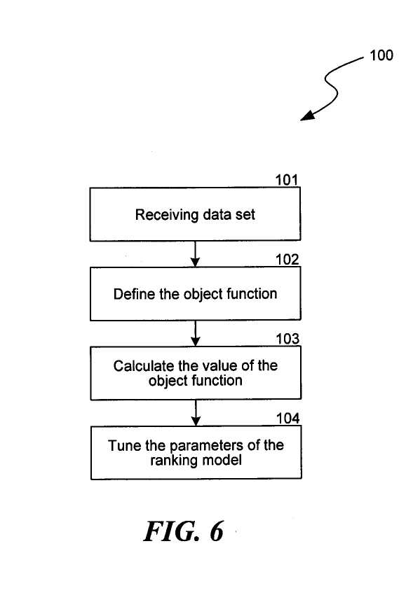

Second, the cross entropy loss is not very sound. Again, we look at the case of ranking two objects. g=(g₁,g₂) denotes the ranking scores of the predicted result. g_{ψ} denotes the ranking scores of the ground truth (depending on the mapping function). Similar to the discussions in the likelihood loss, the cross entropy loss only depends on the quantity d. FIG. 3A illustrates the relation between g, g_{ψ}, and d. FIG. 3B shows the cross entropy loss as a function of d. As can be seen that the loss function achieves its minimum at point d_{g}_{_{ψ}}, and then increases as d increases. That means it can heavily penalize those correct rankings with higher confidence. Note that the mapping function also affects the penalization. According to mapping functions, the penalization on correct rankings can be even larger than that on incorrect rankings.

Third, it is easy to see that the cross entropy loss is continuous and differentiable. It is also convex because the log of a convex function is still convex, and the set of convex function is closed under addition. However, it cannot be computed in an efficient manner. The time complexity is of exponential order to the number of objects.

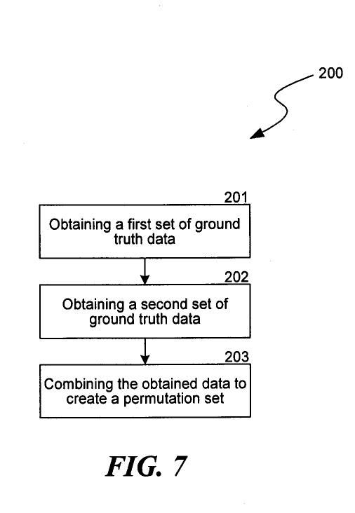

FIG. 4 provides a summary of the properties of the loss functions. All the three loss functions as aforementioned are consistent, as well as continuous and differentiable. The likelihood loss is better than the cosine loss in terms of convexity and soundness, and is better than the cross entropy loss in terms of time complexity and soundness.

The following description covers general descriptions of various elements of the invention, followed by details of particular embodiments. The immediate section provides details of the permutation likelihood. The basic idea is to define the conditional likelihood of any permutation, given the feature vector of the documents and the ranking model ω, e.g., P(π|X;ω); and then example how likely the permutations of ground truth can be generated.

Based on the permutation probability defined by the Luce Model, it is not difficult to get that for a given permutation π,

$$P ( π \vert X ; ω ) = {\prod }_{t = 1}^{n} \frac{ϕ ( ω \cdot {X}_{π ( t )} )}{{\sum }_{k = t}^{n} ϕ ( ω \cdot {X}_{π ( k )} )} \qquad ( 1 A )$$

Where X_{π(t)} is the feature vector of document π(t).
Suppose, the ground truth is a full list (or a certain permutation π*), we can easily get the likelihood of the ground truth as below.

$$P ( {π}^{*} \vert X ; ω ) = {\prod }_{t = 1}^{n} \frac{ϕ ( ω \cdot {X}_{{π}^{*} ( t )} )}{{\sum }_{k = t}^{n} ϕ ( ω \cdot {X}_{{π}^{*} ( k )} )} \qquad ( 2 A )$$

Then for a set of training queries (Q queries in total), if we assume their independency, we can get the corresponding log likelihood as follows.

L(ω)=Σᵢ₌₁^{Q}log P(π_{q}_{ᵢ}*|X_{q}_{ᵢ};ω) (3A)

Considering that in practice, the ground truth is usually ordered categories or pairwise preferences, we can hardly represent it as a certain permutation. Instead, we use a set to represent all possible permutations corresponding to the ground truth. First, for the ordered categories (suppose there are M categories in total), we actually have the ground truth with the following format (ordered categories):

G⁽¹⁾={d₁⁽¹⁾,d₂⁽¹⁾, . . . ,dₙ^{₍₁₎}⁽¹⁾}> . . . >G^{(M)}={d₁^{(M)}d₂^{(M)}, . . . ,dₙ^{_{(M)}}^{(M)}} (4)

Then, we can define the collection of the ground truth in terms of permutations as follows.

$${Ω}^{*} = \{ π \vert \begin{matrix}π ( {j}_{t}^{( 1 )} ) ∈ {G}^{( 1 )} , {j}_{t 1}^{( 1 )} \neq {j}_{t 2}^{( 1 )} if t 1 \neq t 2 , ∀ {j}_{t}^{( 1 )} , {j}_{t 1}^{( 1 )} , {j}_{t 2}^{( 1 )} ∈ \{ 1 , … , {n}^{( 1 )} \} \\ ⋮ \\ π ( {j}_{t}^{( M )} ) ∈ {G}^{( M )} , {j}_{t 1}^{( M )} \neq {j}_{t 2}^{( M )} if t 1 \neq t 2 , ∀ {j}_{t}^{( M )} , {j}_{t 1}^{( M )} , {j}_{t 2}^{( M )} ∈ \{ \begin{matrix}{\sum }_{l = 1}^{M - 1} {n}^{( l )} + \\ 1 , … , {\sum }_{l = 1}^{M} {n}^{( l )}\end{matrix} \}\end{matrix} \} \qquad ( 5 A )$$

In this case, since human judges have reviewed each document in the training data and assigned a relevance level to it, we can regard the labeling data as “complete” and each permutation in Ω* is a one of the desired ground-truth ranking. Therefore, we can represent the log likelihood of the ground-truth data based on the following marginal distribution as follows.

L(ω)=Σᵢ₌₁^{Q} log Σ_{πεΩ*}_{_{qi}}P(π|X_{q}_{ᵢ};ω) (6A)

Second for the pairwise preference, we actually have the ground truth like this.

G={(d₁⁽ⁱ⁾,d₂⁽ⁱ⁾)|d₁⁽ⁱ⁾>d₂⁽ⁱ⁾,i ε {1, . . . ,M}} (7A)

Then, we can define the collection of the ground truth in terms of permutations as follows.

Ω*={π|j₁<j₂, if π(j₁)=d₁⁽ⁱ⁾ and π(j₂)=d₂⁽ⁱ⁾,∃(d₁⁽ⁱ⁾,d₂⁽ⁱ⁾)εG} (8A)

For this pairwise preference data, we can have two different ways of defining the likelihood. First, we can choose to define the log likelihood based on the marginal distribution, just like that for the case of ordered category. Second, we notice it is usual that the pairwise preference data is incomplete. As a result, the labeling results might only be necessary conditions for a permutation of documents to be the desired ranking. That is, a desired ground-truth ranking must satisfy these pairwise constraints, however, a ranking list satisfying the constraints might not be the desired ranking because it might violate user's preferences on other “unspecified” pairs. Therefore, we can only say that there is at least one permutation in Ω is the desired ranking. Note that in this sense, the problem turns out to be very similar to “multi-instance learning” in nature [3]. As for this case, we can represent the log likelihood of the ground truth as follows (for ease of reference, we will call (9) the multi-instance log likelihood).

L(ω)=Σᵢ₌₁^{Q} logmax_{πεΩ*}_{_{qi}}P(π|x_{q}_{ᵢ};ω) (9A)

Note that, besides the above discussions on ordered category and pairwise preference data, we may have other types of ground truth, and may have other definitions of the log likelihood accordingly. Anyway, once we have defined the likelihood, we can find the best ranking model ω by maximum likelihood estimation.

The following description covers the details of the Maximum likelihood by gradient descent. Gradient descent is a widely-used method for maximization. If we use gradient descent to maximize the log likelihood derived in the previous section, we must encounter the derivative of P(π|x;ω). So we first give the deduction of this term here.

For clarity and simplicity, we still assume the linear model as in the ListNet paper. That is, we define

$${h}_{t} ( π , ω ) {=}^{Δ} \frac{ϕ ( ω \cdot {X}_{π ( t )} )}{{\sum }_{k = t}^{n} ϕ ( ω \cdot {X}_{π ( k )} )} , \qquad ( 10 A )$$

so that

P(π|X;ω)=Πₜ₌₁ⁿhₜ(π,ω) (11A)

### Then,

$$\begin{matrix}\frac{\partial p ( π \vert X ; ω )}{\partial ω} = \frac{\partial }{\partial ω} ( {\prod }_{t = 1}^{n} {h}_{t} ( π , ω ) ) \\ = ( {\sum }_{t = 1}^{n} \frac{\frac{\partial {h}_{t} ( π , ω )}{\partial ω}}{{h}_{t} ( π , ω )} ) {\prod }_{t = 1}^{n} {h}_{t} ( π , ω ) .\end{matrix} \qquad ( 12 A )$$

When using exponential function as the φ function, we have the following simplified results for

$$\frac{\partial {h}_{t} ( π , ω )}{\partial ω} .$$

$$\begin{matrix}\frac{\partial {h}_{t} ( π , ω )}{\partial ω} = \frac{\partial }{\partial ω} \frac{exp ( ω \cdot {X}_{π ( t )} )}{{\sum }_{k = t}^{n} exp ( ω \cdot {X}_{π ( k )} )} \\ = \frac{{X}_{π ( t )} exp ( ω \cdot {X}_{π ( t )} )}{{\sum }_{k = t}^{n} exp ( ω \cdot {X}_{π ( k )} )} - \\ \frac{exp ( ω \cdot {X}_{π ( t )} ) {\sum }_{k = t}^{n} {X}_{π ( k )} exp ( ω \cdot {X}_{π ( k )} )}{{( {\sum }_{k = t}^{n} exp ( ω \cdot {X}_{π ( k )} ) )}^{2}}\end{matrix} \qquad ( 13 A )$$

2.1.1 Maximum likelihood for the case of ordered category Considering that

$$L ( ω ) = {\sum }_{i = 1}^{Q} log {\sum }_{π ∈ {Ω}_{{q}_{i}}^{*}} P ( π \vert {X}_{{q}_{i}} ; ω ) \qquad ( 14 A )$$

the gradient of the log likelihood is

$$\frac{\partial L ( ω )}{\partial ω} = {\sum }_{i = 1}^{Q} \frac{{\sum }_{π ∈ {Ω}_{{q}_{i}}^{*}} \frac{\partial P ( π \vert {X}_{{q}_{i}} ; ω )}{\partial ω}}{{\sum }_{π ∈ {Ω}_{{q}_{i}}^{*}} P ( π \vert {X}_{{q}_{i}} ; ω )} \qquad ( 15 A )$$

With this gradient, one can simply perform gradient decent to maximize the log likelihood and learn the model parameter ω. Note that in the above deductions, we give the overall gradient for all queries. Actually like many practices in optimization, we have two choices here. First, we can use the above overall gradient to learn the model parameter directly. However, this “batch” gradient decent method usually converges slowly. Alternatively, we can use the gradient of each query to update the model parameter and perform the task in a “sequential” or “stochastic” manner.

The following description covers the details of the maximum likelihood for the case of the pairwise preference. In this case, if we still following the definition of log likelihood based on marginal distribution, the optimization process is almost the same as that for the case of ordered category. However, if we use the multi-instance log likelihood as in (9), the situation becomes a little complicated because of the “max” in the objective function itself. To tackle the problem, we propose using alternative optimization. Specifically,
1) We assume the model parameter ω is given as ω*, and thus we can select the most desired permutation as π=max_{πεΩ*}_{_{qi}}P(π|X_{q}_{ᵢ};ω).
2) We formulate the gradient as

$$\frac{\partial L ( ω )}{\partial ω} = {\sum }_{i = 1}^{Q} \frac{ \frac{\partial P ( {π}^{*} \vert {X}_{{q}_{i}} ; ω )}{\partial ω}}{P ( {π}^{*} \vert {X}_{{q}_{i}} ; ω )} ,$$

and conduct gradient decent to get the best model parameter ω*.
The problem is that we do not have the guarantee that the above alternative optimization can converge. But in practice, the convergence can be achieved most likely, especially when we introduce some decaying factor to the update of w.

The following description covers the details of the testing of the model. A common approach of using ListMLE for testing is as follows. We first simply apply the corresponding linear model ω to the testing documents and assign a score <ω, x> to each of them. After that, we can rank the documents according to the descent order of the scores.

Actually this operation with O(n) complexity also corresponds to a maximum likelihood prediction. It can be proven that the ranked list π* according to the descent order of the scores <ω, x>, that is, (ω,X_{π*(t)})>(ω,X_{π*(s)})∀t<s, then we have

π*=argmax_{π}P(π|X;ω) (16A)

The following description covers the details of the regularized ListMLE. Only maximizing the log likelihood on the training set is not sufficient when the number of training examples is limited. In MSN extractions, tens of thousands of queries are labeled, while the number of features are over one thousands. In this case, we can hardly regard the training data as sufficient. A common approach to solve the problem is to add a regularization item to the objective function, to reduce the variance of the learning algorithm. In other words, we can revise the objective function (14) as follows.

L*(ω)=Σᵢ₌₁^{Q}log Σ_{πεΩ*}_{_{qi}}P(π|X_{qi};ω)+β∥ω∥² (18A)

And accordingly, we can update the gradient as below.

$$\frac{\partial L ( ω )}{\partial ω} = {\sum }_{i = 1}^{Q} \frac{{\sum }_{π ∈ {Ω}_{{q}_{i}}^{*}} \frac{\partial P ( π \vert {X}_{{q}_{i}} ; ω )}{\partial ω}}{{\sum }_{π ∈ {Ω}_{{q}_{i}}^{*}} P ( π \vert {X}_{{q}_{i}} ; ω )} + 2 β ω \qquad ( 19 A )$$

In addition to the afore-updated objective function and gradient, other part of ListMLE remains unchanged. That is, we can still use gradient descent to learn the model parameter ω, and apply it to sort the testing document.

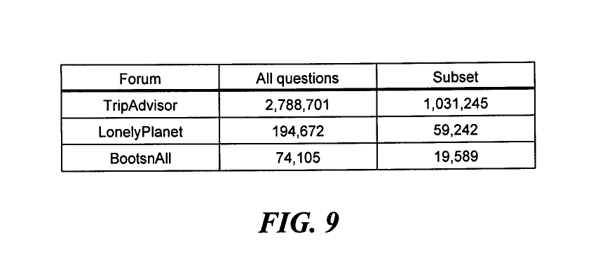

As described above, one aspect of the present invention is to define an objective function as the likelihood of ground truth based on a Luce model. With reference to FIG. 6, one embodiment of this aspect will be described. The process 100 involves the analysis of gathered data to ultimately determine if the ranking results on a given ranking model are accurate or not. In the first step 101, the process involves the receipt of a data set to be analyzed. The data set can include a list of search queries, documents to be searched and related metadata. The data set may be gathered from a number of sources, such as the query log of a search system. The metadata, which is also referred to as labels, can be human added information, or tag information that may have been automatically associated with the documents. The metadata can describe a number of things about the documents, for example, it may say that the document is “bad” or “good,” or it may state that it is “valued” or “not valued,” etc.

Using the equations, as shown in step 102, the process 100 involves defining an objective function. Next, in step 103, a value of the objective function is calculated. The value is used to measure whether the ranking results on a given ranking model is accurate or not. The process also includes a tuning step 104, where the process modifies the parameters ranking model depending on the value of the objective function. The process can then run several iterations of the above-described process to more accurately tune the model. Ultimately, as parameters of the ranking model are changed, the ranking model becomes more accurate, which in turn may be used to better assist a search system, such as a page ranking system.

Also summarized above, techniques of the present invention also provide a way of representing different kinds of ground truths as a constraint set of permutations. This is one way to define the objective function in situations where all of the documents may not have ranking data. In order to define and fully utilize the Luce model, it is preferred to have all of the labeling data as permutations. The reason for this is because human added metadata (labels) may not give enough data to rank all of the documents. In some cases, human added metadata can only give an independent reading on ranked documents. For example, human added labels can give a pairwise ranking, which gives a relative ranking for two documents. In other examples, the human added labels may only give categorical information, such as “good,” “bad,” “fair,” etc. Given this situation, the obtainable ground truth is different than that in the Luce model.

To provide a solution, the invention represents the training data in a way that can fit into the Luce model. Equations 4A, 5A, 7A and 8A show two examples. One example includes the use of categories. When the labels involved categories, e.g., “perfect” or “excellent,” these equations show how we can represent these labeling in a set of permutations. In another example, shown specifically in Equations 7A and 8A, the human added labels are given as a pairwise ranking. This solution is to represent them as a constrained set of the permutation. Once all of the labels are mapped into a permutation set, the Luce model can be used to define an objective function.

For illustrative purposes, an example data set is provided. In an example using three documents A, B, and C they are have respective labels, good, good and bad. Based on the labels, the output currently has two permutations, total ordering of ABC and BAC. Therefore, in the end, the ground truth data has two main types, category and pairwise, and the process generates a uniform representation, which may be a group of permutations.

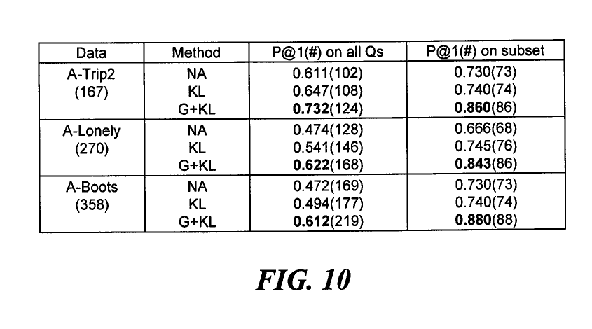

FIG. 7 illustrates this process 200. As shown in block 201 the first step includes obtaining a first set of ground truth data. Next, as shown in block 202, the process 200 includes the step of obtaining a second set of ground truth data. As noted above the ground truth data can be in a number of forms, including but not limited to, pairwise or category data. Next, at block 203, the process 200 includes the step of combining the first set of ground truth data and the second set of ground truth data into a permutation set, wherein the permutation set is configured and arranged to be processed in a Luce model for ranking.

In yet another aspect, the present invention provides techniques for learning the model parameter by maximizing the likelihood of the ground truth. As described above and illustrated in an example below, this aspect of the invention optimizes an objective function.

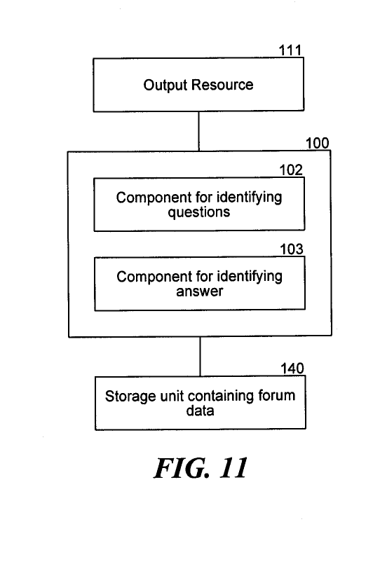

In a given illustrative example, we introduce three documents. In each document there are five features for the representation of each document. The model parameter (omega) has the same dimension as the features. Given this example data set and with reference to FIG. 8, the process 300 will now be explained. In the first step 301 the process computes the likelihood. Having the likelihood, the process moves to step 302 where it computes the gradient with respect to each feature dimension. The model parameter has five dimensions omega 1 to omega 5. More specifically, the process computes the gradient of the likelihood with respect to the five components of Omega. This is illustrated above in the description of Equation 12A. Here, the process computes the partial derivation of the likelihood (P) with respect to the model parameter omega. The partial derivation is the gradient. Since the likelihood (P) is calculated using all of the three documents, it actually can be regarded as a sum of the three likelihood. The sum is illustrated above in Equation 14A.

For the three documents, the process has mapped the elements into a constrained permutation set, ABC or BAC. The two permutations are both valid. So, the process takes the summation of the two valid permutations to compute the likelihood. Then the process obtains the gradient of the likelihood with respect to the model parameter omega. This is described above in the description of Equation 12A. After that, in step 303, the process changes the model parameter omega, wherein the direction of the change is dictated by the gradient. For example, if the gradient is −1 then the process will add to the Omega with a positive number. After changing the Omega, the original likelihood will be maximized. The result model, in the current example, will be in the form of 5 components for each document, e.g., 5 real numbers. As a result, the values can be used to determine the performance and accuracy of a ranking model.

The above process can also be used to define a relevant score of a document that is newly added to a collection of ranked documents. In such an application, the process uses the model parameter to produce a relevancy score for the newly introduced document.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method for tuning a ranking model used in conjunction with a page search system, the system comprising:
obtaining a data set, wherein the data set includes queries, documents and metadata;
defining an objective function;
calculating the value of the objective function, wherein the value of the objective function is dependent on the data set; and
tuning the parameters of the ranking model associated with the data set for use in conjunction with a page search system, the tuning of the parameters being based on the value of the objective function, wherein the tuned parameters of the ranking model ultimately change the ranking of the documents in the data set such that the ranking is more consistent with the metadata.

2. The method of claim 1, wherein the method further comprises, running multiple iterations of the method to calculate a new value of the objective function.

3. The method of claim 2, wherein the method determines if the subsequent iteration of the method produces an improved value, if the value of the objective function improves in the subsequent iteration the method continues to further iterations to tune the parameters in the same direction in subsequent iterations.

4. The method of claim 1, wherein the method utilizes a likelihood of loss calculation.

5. The method of claim 1, wherein the objective function is defined as the likelihood of ground truth based on a Luce model.

6. The method of claim 1, wherein the tuning process includes the use of a Stochastic Gradient Descent algorithm, wherein the value of the Stochastic Gradient Descent algorithm is configured to determine the direction in which the parameters are changed.

7. The method of claim 1, wherein the method further comprises the step of changing the ranking results of the documents, wherein the changed ranking results are dictated by the changed parameters of the ranking model.

8. A system storing code, which when executed, processes the method of claim 1.

9. A computer-readable medium storing code, which when executed, run the method of claim 1.

10. A method for preparing data sets for document ranking, wherein the method is configured to utilize different kinds of ground truth as a constraint set of permutations, wherein the method comprises:
obtaining a first set of ground truth data;
obtaining a second set of ground truth data; and
combining the first set of ground truth data and the second set of ground truth data into a permutation set, wherein the permutation set is configured and arranged to be processed in a Luce model for ranking.

11. The method of claim 10, wherein the first set of ground truth data is a pairwise dataset.

12. The method of claim 10, wherein the second set of ground truth data is a category dataset.

13. A system storing code, which when executed, processes the method of claim 8.

14. A computer-readable medium storing code, which when executed, run the method of claim 1.

15. A method for optimizing a ranking model, wherein the method comprises:
obtaining a dataset, wherein the dataset contains a plurality of feature dimensions for individual documents;
computing a likelihood related to the dataset, wherein the plurality of feature dimensions for individual documents is used to compute the likelihood;
computing a gradient with respect to each feature dimension; and processing modifications to a parameter of the ranking model, wherein the direction of the modification is determined by the direction of the gradient.

16. The method of claim 15, wherein computing the related likelihood is derived by the use of a Luce model.

17. The method of claim 15, wherein the modifications to a parameter of the ranking model are configured to maximize the likelihood related to the dataset.

18. The method of claim 15, further comprising:
obtaining a new document, wherein the document has a related dataset, the related dataset contains a plurality of feature dimensions for individual documents; and
utilizing the model parameter to produce a relevancy score for the newly introduced document.

19. A system storing code, which when executed, processes the method of claim 15.

20. A computer-readable medium storing code, which when executed, run the method of claim 15.
